(19) United States
(12) Patent Application Publication
(10) Pub. No.: US 2024/0397584 A1
(43) Pub. Date: Nov. 28, 2024

(54) Electrical heating layer and method for its manufacture

(71) Applicant: Erhard Rohrmoser, Gqeberha (Port Elizabeth) (ZA)

(72) Inventor: Erhard Rohrmoser, Gqeberha (Port Elizabeth) (ZA)

(21) Appl. No.: 18/668,860

(22) Filed: May 20, 2024

(30) Foreign Application Priority Data
May 24, 2023 (DE) 102023113534.1
Feb. 15, 2024 (EP) 24157970.5

(51) Int. Cl. H05B 3/36

(52) U.S. Cl. CPC H05B 3/36

(57) ABSTRACT

An electrical heating layer comprising a planar and electrically conductive layer as well as to a first strip-shaped electrode and a second strip-shaped electrode, wherein the first electrode is arranged on the layer at a distance from the second electrode, so that a flow of electric current is enabled from the first electrode through the layer to the second electrode, and wherein the layer is designed to convert electrical energy into heat due to its electrical resistance during the current flow. The heating layer according to the invention is characterized in that the first electrode and the second electrode are made of zinc or a zinc alloy. The invention also relates to a method for manufacturing an electrical heating layer according to the invention.

### CROSS-REFERENCE TO RELATED APPLICATIONS

This application claims priority pursuant to 35 U.S.C. 119 (a) to German Application No. 102023113534.1, filed May 24, 2023, and to European Application No. 24157970.5, filed Feb. 15, 2024, which applications are incorporated herein by reference in their entireties.

### FIELD OF THE INVENTION

The invention relates to an electrical heating layer according to the preamble of claim 1 and to a method for its manufacture.

### BACKGROUND

In the prior art, so-called surface heating systems are known for heating rooms in buildings in particular. There, such surface heating systems are usually installed on or in the walls or on or in the floors. The surface heaters are usually supplied with either electrical energy or heated water. One specific embodiment of the named electrical surface heaters is represented by heating systems in which an electric current is conducted through a conductive foil, which can be located e.g. directly under a laminate floor or tiled floor. Electrically conductive paint coatings are also known in this context. The room is heated here substantially by infrared heat radiation, and the heating effect begins comparatively immediately. The heat output of such an electrical heating system depends on the applied voltage, the ohmic resistance, and the length of the heating wire used. It is therefore variable within a wide range, depending on requirements. Electronic control units can, for example, supply electrical energy in the form of pulses, thus ensuring simple and cost-effective control of the energy supply.

A corresponding electric heating foil for use in a wall, ceiling or floor heating system is known for example from EP 2 023 688 A1. The known surface heating element comprises an electrically conductive heating foil with electrical contacts formed in the shape of a web in two edge areas of the heating foil, as well as a bottom layer and a top layer between which the heating foil is embedded. The top layer is formed by a plastics material film and the bottom layer by a non-woven fabric.

DE 44 47 407 A1 discloses a method for manufacturing a mechanically resilient and flexible laminated composite as a low-voltage heating element for a planar heating element. The layer composite comprises fibrous or filamentary carbon modifications that have a temperature-independent electrical resistance. The heating element is embedded in a curable synthetic resin and connected to a power source at opposite ends.

An electrically conductive paper structure with electrodes formed from an electrically conductive ink is also known from EP 4 136 291 A1. The ink is absorbed into the electrically conductive paper structure so that there is no significant increase in the thickness of the wallpaper.

However, the known heating foils or surface heating elements are disadvantageous in that the electrodes used to provide them with current, if they are made of conductive ink, have only low electrical conductivity, which leads to increased electrical resistance at the electrodes and thus limits the electrical supply of power and therefore the generation of heat in the heating element. If copper foil strips are used as the electrode material, which is usually the case, these allow a comparatively high current, but are comparatively susceptible to corrosion and have comparatively high material costs. In addition, copper foil strips are mechanically sensitive and are subject to a non-negligible risk of damage or destruction when attached to the heating element, so that the corresponding heating element may be lost as scrap.

It is an object of the present invention to propose an improved electrical heating layer.

### BRIEF SUMMARY

According to the invention, this object is achieved by the electrical heating layer according to claim 1 and by the method for manufacturing the electrical heating layer according to claim 10. Advantageous embodiments and developments of the invention result from the dependent claims.

The invention relates to an electrical heating layer comprising a planar and electrically conductive layer as well as to a first strip-shaped electrode and a second strip-shaped electrode, wherein the first electrode is arranged on the layer at a distance from the second electrode so that a flow of electric current is enabled from the first electrode through the layer to the second electrode, and wherein the layer is designed to convert electrical energy into heat during the current flow due to its electrical resistance.

An electrical heating layer is therefore provided, i.e., a layer that can be heated by electrical current and is correspondingly designed to conduct electricity so that a flow of current through the heating layer is in principle enabled. As the heating layer also has an electrical resistance, the electrical energy that is conducted through the heating layer by the current flow is at least partially converted into heat. The heat generated in this way can be used for example to heat a region surrounding the heating layer.

The layer is planar, where the term “planar” in the sense of the invention is understood to mean a substantially two-dimensional layer whose height is negligibly small compared to its length and width. The length and width of the layer are preferably each at least 25 cm up to several meters. The height of the layer, on the other hand, is preferably less than 1 cm, particularly preferably less than 5 mm, and quite particularly preferably less than 3 mm. A layer height of less than 1 mm is also conceivable and preferred. For example, the layer can have a length of 250 cm, a width of 45 cm, and a height of 0.2 mm.

Different approaches can be considered as materials for the heating layer, for example plastics material carrier foils or plates containing small metal particles, textile materials such as fleece, paper, or fabrics in which wire loops or wire nets are attached, or electrically conductive paints or lacquers applied to a suitable carrier layer and for example containing carbon fibers. All these materials are fundamentally suitable for use as electrical heating layers within the meaning of the invention.

A first strip-shaped electrode and a second strip-shaped electrode are provided to enable simple and efficient provision of current to the heating layer, and thus to enable the flow of current through the heating layer in the first place. The first and second electrodes are arranged on the heating layer in such a way that the first electrode is in electrical contact with the heating layer and the heating layer is in electrical contact with the second electrode. The electrical contacts are advantageously designed in such a way that the electrical resistance at the contacts is as low as possible. This can be achieved for example by connecting the first and second electrodes to the heating layer over as large an area as possible, i.e., by using comparatively large contact surfaces for the contacts.

The first and second electrodes are spaced apart on the heating layer so that a current can flow from the first electrode through the heating layer to the second electrode when a corresponding current is applied.

The exact distance between the first electrode and the second electrode is advantageously calculated in advance in accordance with the electrical resistance of the heating layer between the first and second electrodes and in accordance with a desired application of voltage to the heating layer. The higher the resistance of the heating mat, the closer together the first and second electrodes can be arranged. On the other hand, the higher the desired voltage application, the greater the distance between the first electrode and the second electrode is to be chosen.

Within the meaning of the invention, the term “strip-shaped” is understood to mean an essentially two-dimensional shape whose length is many times greater than its width, i.e., a “strip.” For example, the length can be at least five times greater than the width.

Advantageously, the length of the first and second electrodes corresponds in each case to the length of the heating layer.

The strip shape of the first and second electrodes favors the production of electrical contacts between the heating layer and the first and second electrodes, which on the one hand allow a high current flow due to their comparatively large contact surfaces and the associated low electrical resistance, and on the other hand can contact the heating layer over their entire length, so that as far as possible the entire surface of the heating layer is provided with current and contributes to heat generation.

If the heating layer is so large that the electrical resistance of the layer between the first electrode and the second electrode is too high to allow the current flow required to generate the desired heating power, further electrodes can also be provided that allow additional current to flow through the layer. For example, four, six, or eight electrodes can be arranged on the layer, preferably at the same distance from each other, in order to reduce the path length and thus the resistance between two electrodes. Alternatively, the heating layer can be kept correspondingly small and, if necessary, multiple smaller heating layers, which can be provided with current independently of each other, can be arranged next to each other.

The current can be supplied by direct current or direct voltage or by alternating current or alternating voltage.

According to the invention, it is now provided that the first electrode and the second electrode are made of zinc or a zinc alloy. Compared to the known electrodes made of copper, the electrodes according to the invention made of zinc or a zinc alloy have a significantly increased material toughness, so that the electrodes are not damaged or even destroyed during their application to the heating layer, or at least much less frequently.

Zinc or suitable zinc alloys are also substantially more resistant to corrosion than copper. They are also easier to paint over, for example with so-called carbon heating paints.

A further advantage of zinc or a zinc alloy over copper as a material for the electrodes is that zinc or a zinc alloy is significantly cheaper than copper and no material shortage is to be expected.

The disadvantage of the lower electrical conductivity of zinc or the zinc alloy compared to copper is hardly significant when used as an electrode material for the heating layers, as it can be easily compensated for with a slightly increased material thickness.

According to a preferred embodiment of the invention, it is provided that a first electrical supply line for providing current to the first electrode and a second electrical supply line for providing current to the second electrode are also strip-shaped and are made of zinc or a zinc alloy. This means that the aforementioned advantages of zinc or the zinc alloy can also be transferred to the electrical leads of the first electrode or the second electrode.

The first electrical supply line represents a current path from an electrical energy source, for example a household socket or an electrical regulator, to the first electrode. Similarly, the second electrical supply line represents a current path from the electrical energy source, for example the household socket or the electrical controller, to the second electrode.

The electrical regulator is advantageously designed to control the provision of current to the first or second electrode.

In addition, the first electrical supply line and the second electrical supply line are also strip-shaped. This makes it possible to ensure the overall planar appearance of the electrical heating layer even in the area of the supply lines which are required for the operation or provision of current to the heating layer.

The advantage of this, particularly when using several electrical heating layers as wallpaper in an interior, is that electrical heating layers further away from the energy source, in particular from the electrical regulator, can also be easily contacted by means of the electrical supply lines without the need for conventional cables, which are typically round and comparatively thick, and would therefore detract from the visual impression of the wallpaper.

The first electrical electrode and the second electrical electrode can for example be arranged within an electrically insulating self-adhesive tape. This particularly simplifies the visually unobtrusive attachment of the first electrode and the second electrode, for example to a wall.

Advantageously, the first electrical supply line and the second electrical supply line are made from the same material as the first electrode and the second electrode, for example from the same zinc alloy. This results in particularly good electrical connections with only low electrical resistance between the first electrical supply line and the first electrode and between the second electrical supply line and the second electrode.

According to a further preferred embodiment of the invention, it is provided that the zinc alloy comprises tin and/or lead and/or cadmium and/or iron and/or copper and/or aluminum as an alloy component. Zinc alloys which contain one or more of the alloy components mentioned have proven to be particularly suitable for use as material for the first and second electrodes due to their electrical and mechanical properties.

It is particularly preferred that the zinc alloy has the following composition: Tin≥0.001%, lead≥0.05%, cadmium≥0.005%, iron≥0.02%, copper≥0.04%, aluminum≥0.03%, zinc≥99.95%. The percentages refer to the respective weight proportion of the alloy.

According to a further preferred embodiment of the invention, it is provided that the layer comprises electrically conductive fibers. It is therefore at least partially a textile heating layer. Such a heating layer is comparatively flexible and at the same time mechanically stable. It is also very easy to process.

According to a highly preferred embodiment of the invention, it is provided that the layer is formed as a carbon fiber layer, as carbon paper, or as a carbon paint coating on a carrier layer, wherein the electrically conductive fibers are formed as carbon fibers. Carbon fibers enable good electrical conductivity in combination with particularly high mechanical flexibility and loading capacity at the same time.

The carbon fibers can be formed as a pure carbon fiber layer, i.e., can be made exclusively of carbon, or also of carbon paper, in which the carbon fibers are for example applied to an ordinary paper or integrated into an ordinary paper, i.e., are mixed with the paper fibers. The carbon fibers can also be contained in a paint or lacquer and applied to a carrier layer in liquid form. After drying, an electrically conductive carbon coating is then in this case also present on a carrier material.

According to a further preferred embodiment of the invention, it is provided that the first electrode and the second electrode are arranged on the layer by means of an electrically conductive adhesive. The electrically conductive adhesive enables contact between the first electrode and the heating layer as well as between the second electrode and the heating layer, which has good electrical conductivity or low electrical resistance, so that the heating layer can also be charged with comparatively high currents. In addition, the adhesive can be used to create a reliable and cost-effective connection between the first or second electrode and the heating layer.

According to a further preferred embodiment of the invention, it is provided that the first electrode and the second electrode have a planar surface with the layer or are recessed relative to an upper side of the layer. As a result, the heating layer can also be processed particularly well and easily, for example as wallpaper in the interior of a building.

For the purposes of the invention, a “planar surface” is understood to mean a surface that is to the greatest possible extent formed as a two-dimensional plane and has neither depressions nor raised parts. In particular, in this case neither the first electrode nor the second electrode are raised above the layer or elevated relative to the upper side of the layer, nor are they recessed relative to the upper side of the layer or countersunk into the layer. In other words, it is a “smooth” surface.

In the context of the invention, however, the term “recessed into the layer” means that the first electrode and the second electrode are recessed relative to the upper side of the layer, i.e., that the upper sides of the first electrode and the second electrode are situated lower than the upper side of the layer. The upper side of the layer and the upper sides of the first electrode and the second electrode therefore do not form a planar surface and are not formed as a two-dimensional plane. Rather, a common surface of the layer, the first electrode, and the second electrode has a step in the area of the first electrode and of the second electrode.

As the electrodes are never raised above the surface of the heating layer, there is no disturbing visual impression that is unusual in wallpaper. The heating layer can also be used efficiently as underfloor heating, for example under a floor covering such as laminate or vinyl, as the floor covering is not at a distance from the surface of the heating layer due to the electrodes, but can be in full-surface contact with the heating layer, thus promoting heat conduction. Finally, the risk of damage and tearing to the first and second electrodes is also reduced if these are not raised above the surface of the heating layer.

According to a further preferred embodiment of the invention, it is provided that the first electrode and the second electrode each have an adhesive structure for a paint coating on their side facing away from the layer. That is, the surface of the first or second electrode that is not connected to the layer, for example by means of the electrically conductive adhesive, has a special structure in the form of the adhesive structure, so that a coat of paint adheres better. This realization is particularly suitable for paper wallpapers or carbon paper wallpapers that are intended to be painted over with an interior room paint.

According to a further preferred embodiment of the invention, it is provided that the first electrode and the second electrode are each sealed by a polymer strip and/or that the layer is completely sealed by a polymer film at least on a surface comprising the first electrode and the second electrode. The polymer strips or polymer film provide additional mechanical protection, as well as electrical insulation. This type of electrical insulation can be particularly advantageous when voltages in the range of 240 V can be applied, i.e., when current or voltage is applied via a household socket.

The sealing of the first electrode and the second electrode by means of polymer strips is particularly advantageous if the first electrode and the second electrode are recessed relative to the upper side of the layer. This is because the polymer strips, which are arranged on the first and second electrodes, can then be used to raise or thicken the surfaces of the first electrode and the second electrode, which are actually sunk into the layer, to such an extent that the polymer strips have a planar surface with the layer.

PLE or PLV can advantageously be used as the material for the polymer strips or the polymer film. Both polymers provide reliable electrical insulation and prevent the sparkover of electrical voltages and flying sparks.

The invention also relates to a method for manufacturing an electrical heating layer according to the invention, wherein a first strip-shaped electrode is arranged on a planar and electrically conductive layer and wherein a second strip-shaped electrode is arranged on the layer at a distance from the first electrode, so that a flow of electrical current is enabled from the first electrode through the layer to the second electrode.

The method according to the invention is characterized in that the first electrode and the second electrode are made of zinc or a zinc alloy.

The method according to the invention thus enables the manufacture of the heating layer according to the invention. This leads to the advantages already described.

Within the meaning of the invention, it is not required that the layer already have the desired electrically conductive properties before the first electrode and the second electrode are arranged on it. Rather, it is also possible for the layer to be provided with for example a coating of electrically conductive fibers, in particular carbon fibers, after the first and second electrodes have been arranged, in order to produce the desired electrical conductivity. The coating can advantageously be a carbon paint or a carbon lacquer.

According to a preferred embodiment of the invention, it is provided that the first electrode and the second electrode are arranged on the layer by means of an electrically conductive adhesive, wherein the adhesive is applied to the first electrode before the first electrode is arranged and is applied to the second electrode before the second electrode is arranged, or wherein the adhesive is applied on both sides of a first carrier tape which is arranged between the first electrode and the layer, and is applied on both sides of a second carrier tape which is arranged between the second electrode and the layer. As already described, the use of an electrically conductive adhesive enables a simple, cost-effective, and at the same time reliable connection of the first or second electrode to the layer. This also ensures low electrical resistance at the contacts.

In the manufacture of the electrical heating layer according to the invention, the adhesive can be applied to the first or second electrode either before the first or second electrode is arranged, the adhesive being applied in each case to that side of the first or second electrode which is then glued to the layer. This means that the adhesive is first applied to the first or second electrode and the first or second electrode is glued exclusively to the layer or arranged exclusively on the layer.

Preferably, the adhesive is already applied to the first or second electrode during the manufacture of the first or second electrode.

Alternatively, the electrically conductive adhesive can also be applied to both sides of a first or second carrier tape, as described. This means that the carrier tape, which is for example a fabric tape with carbon fibers or a paper tape containing carbon, is provided with the adhesive on both sides before the first or second electrode is arranged on the layer.

In this case, for example the first carrier tape can first be arranged on the first electrode via a first side and then arranged on the layer via a second side together with the first electrode. However, the first carrier tape can just as well first be arranged on the layer via the first side and then the first electrode can also be arranged on the layer via the second side of the carrier tape.

Analogously, the second carrier tape can first be arranged on the second electrode via a first side and then arranged on the layer via a second side together with the first electrode. However, the second carrier tape can just as well first be arranged on the layer via the first side and then the second electrode can also be arranged on the layer via the second side of the carrier tape.

The adhesive can advantageously be provided in heated liquid form for application to the first or second electrode or for application to the first or second carrier tape.

The first carrier tape here advantageously has the same length and width as the first electrode. Likewise, the second carrier strip advantageously has the same length and width as the second electrode.

Equally preferably, the first carrier strip and the second carrier strip can also be formed as double-sided adhesive tape, which does not have to be specially provided with the adhesive for the production of the heating layer according to the invention, but already has this adhesive.

Electrically conductive adhesives are known in the prior art and are widely available with different properties.

According to a particularly preferred embodiment of the invention, it is provided that the first electrode and the second electrode are laminated onto the layer by means of the electrically conductive adhesive with the application of heat and pressure. The application of heat here reduces the viscosity of the adhesive. Together with the application of pressure, this has the result that the adhesive can penetrate comparatively deeper into the layer, resulting on the one hand in improved load-bearing capacity and reliability of the bonded joint. On the other hand, this also improves the electrical conductivity of the contacts so that they have a lower electrical resistance.

According to a further particularly preferred embodiment of the invention, it is provided that the adhesive is melted by the application of heat and is pressed into the layer by the application of pressure, so that it is completely absorbed by the layer and encapsulates fibers of the layer. The adhesive penetrates into previously air-filled spaces between the fibers of the layer and fills them. The application of heat and pressure is coordinated in such a way that the adhesive penetrates completely into the layer and creates the most optimal possible electrical connection there by encapsulating the fibers. Since the adhesive encapsulates the fibers, instead of only touching them in places or only lying against them in places, in an encapsulation the entire surface of the fiber is in contact with the adhesive. This reduces the electrical resistance of the contact between the adhesive and the fibers to a minimum, which allows the heating layer to be provided with comparatively high current flows and thus a correspondingly high heating power.

As the adhesive also fills the previously air-filled spaces between the fibers, there is no longer any room in the layer for sparks to form due to ionized air or the space between the individual fibers. This also promotes the operational reliability of the heating layer.

It is particularly preferred that the heat is applied in such a way that a temperature of at least 130° C. is reached at the first electrode and at the second electrode. The temperature is then transferred from the first electrode or the second electrode to the adhesive, among other things; however, the adhesive is advantageously not heated to 130° C.

According to a further particularly preferred embodiment of the invention, it is provided that the first electrode and the second electrode are also pressed into the layer by the application of pressure and are held in the layer by the adhesive so that the first electrode and the second electrode have a planar surface with the layer or are recessed relative to a surface of the layer. It has been shown that by applying the appropriate pressure, the first and second electrodes can also be pressed into the soft layer due to the fiber structure. The adhesive pressed between the fibers at the same time as the first and second electrodes fuses with the fibers to form a mass that no longer contains any air-filled intermediate gaps and therefore also partially loses its elastic properties. This mass of fibers and adhesive is now able to hold the pressed-in first or second electrode in its pressed-in position so that the first or second electrode has a planar surface with the layer or is even sunk in relation to the top of the layer, i.e., the first or second electrode is situated lower than the rest of the surface of the layer. As already described, this results in the advantages that the visual impression of the heating layer is not impaired, that subsequent use is facilitated, and that the risk of damage and tearing of the first and second electrodes is reduced.

According to a further particularly preferred embodiment of the invention, it is provided that the application of heat and pressure are done simultaneously by a heatable contact pressure element. As a result, the heat and pressure can be applied in the same manufacturing step, which both speeds up and simplifies the manufacturing process and also promotes the interaction between the heat application and the pressure application.

Preferably, a first heatable contact pressure element is provided for the first electrode and a second heatable contact pressure element is provided for the second electrode. This means that the first and second electrodes can be placed on the layer at the same time, which speeds up manufacture.

The heatable contact pressure element can, for example, be designed as an electrically heatable roller that is rolled over the first or second electrode once or several times with the desired contact pressure and temperature.

It is particularly preferable that the heatable contact pressure element is designed not only as a single heatable roller, but as two heatable rollers which apply the heat and pressure to the first and second electrodes from opposite sides, i.e., from the upper side of the heating layer and from the lower side of the layer. This allows a comparatively greater contact pressure to be exerted on the first or second electrode, so that the first or second electrode can be sunk into the layer particularly easily relative to the upper side of the layer.

Still more preferably, the heatable contact pressure element can also comprise four rollers, with two rollers acting on the first and second electrodes from the upper side of the heating layer and two rollers acting on them from the lower side of the heating layer. For example, all four rollers can apply the pressure and one upper and one lower roller can apply the temperature. This enables a still more effective application of the contact pressure to the first or second electrode.

In addition or as an alternative to the application of heat by the heatable contact pressure element, in particular by the heatable roller or heatable rollers, heat can also be applied to the first and second electrodes by hot air, induction, or laser irradiation. For example, the heat can be applied in two stages, where first there is a first application of heat using hot air and then there is a second application of heat using the heatable roller until the desired final temperature is reached.

According to a further particularly preferred embodiment of the invention, it is provided that the first electrode and the second electrode are cooled after being arranged on the layer. This accelerates the curing of the adhesive so that the first and second electrodes are fixed in position immediately after they are put in place. This prevents the first or second electrode from slipping while the adhesive is still liquid, which would be a production error and would make the heating layer into scrap. In addition, the overall manufacturing process can be accelerated, as the cooling and curing of the adhesive is accelerated.

The cooling of the first or second electrode and thus also of the adhesive can advantageously be carried out by an electrically coolable roller, which is rolled over the first electrode and the second electrode, in particular under a prespecifiable pressure. This means that the application of pressure that was previously done during the heating of the adhesive can also be maintained during cooling and curing.

The rolling movement of the coolable roller can also be repeated once or several times.

In the following, the invention is explained by way of example on the basis of the embodiments shown in the figures.

### BRIEF DESCRIPTION OF THE DRAWINGS

In the figures:

FIG. 1 schematically shows, by way of example, a possible embodiment of the method according to the invention for manufacturing an electrical heating layer in the form of a flow chart,

FIG. 2 schematically shows, by way of example, a possible embodiment of an electrical heating layer according to the invention, and

FIG. 3 schematically shows, by way of example, a cross-section of a portion of a possible embodiment of an electrical heating layer according to the invention.

### DETAILED DESCRIPTION OF THE INVENTION

Identical objects, functional units, and comparable components are designated with the same reference signs across all the figures. These objects, functional units, and comparable components are identical in terms of their technical features, unless explicitly or implicitly stated otherwise in the description.

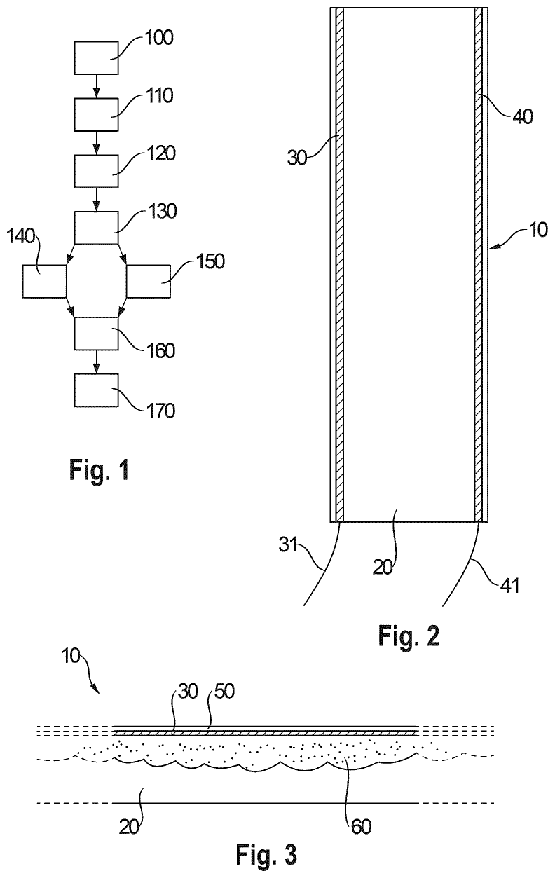

FIG. 1 shows, schematically and by way of example, a possible embodiment of a method according to the invention for manufacturing an electrical heating layer in the form of a flow chart.

In a first method step 100, a planar and electrically conductive layer 20, for example a carbon paper 20, as well as a first electrode 30 and a second electrode 40 are provided. The first electrode 30 and the second electrode 40 are strip-shaped, for example each with a length of 300 cm and a width of 4 cm. In addition, the first electrode 30 and the second electrode 40 are made of a zinc alloy according to the example. Layer 20 also has a length of 300 cm and a width of 50 cm according to the example.

In the following step 110, an electrically conductive adhesive 60 is applied to the first electrode 30 and to the second electrode 40.

Then, in step 120, the arrangement of the first electrode 30 and the second electrode 40 on the layer 20 begins. To do this, the first electrode 30 and the second electrode 40 are first positioned and aligned on the layer 20. The alignment and positioning are carried out according to the example in such a way that the first electrode 30 is positioned at a first longitudinal edge of the layer 20 and the second electrode 40 is positioned at a second longitudinal edge of the layer 20. The alignment takes place along the longitudinal edges of the layer 20 and parallel to each other.

In step 130, the first electrode 30 and the second electrode 40 are laminated onto the layer 20 by means of the electrically conductive adhesive 60 with application of heat and pressure. The heat is applied in such a way that the first electrode 30 and the second electrode 40 are each heated to 145° C. according to the example. The heat generated flows off to the surrounding environment of the first electrode 30 and the second electrode 40, including onto the adhesive 60. However, the adhesive 60 does not reach the temperature of 145° C.

Nevertheless, the application of heat has the result in step 140 that the adhesive 60 melts and becomes comparatively thin and liquefied.

At the same time, the application of pressure in step 150 has the result that the adhesive 60 and the first electrode 30 and the second electrode 40 are pressed into the layer 20 and the adhesive 60 is completely absorbed by the layer 20 and encapsulates the carbon fibers of the layer 20.

For example, heat and pressure are applied simultaneously by a heatable contact pressure element, which is designed as an electrically heatable roller and is rolled multiple times over both the first electrode 30 and the second electrode 40.

In the following step 160, according to the example a further roller is rolled several times over the first electrode 30 and the second electrode 40 with application of pressure, although this further roller can be cooled electrically. As a result, the adhesive 60 cures quickly and the first electrode 30 and the second electrode 40 are firmly bonded to the layer 20. By pressing the first electrode 30 and the second electrode 40 into the layer 20, in particular also during cooling or curing, the first electrode 30 and the second electrode 40 are held in the layer 20 and form a planar surface with the upper side of the layer 20. An electric current can flow between the first electrode 30 and the second electrode 40 when the first electrode 30 and the second electrode 40 are supplied with current.

Finally, in process step 170, the first electrode 30 and the second electrode 40 are each sealed with a polymer strip. This protects the first electrode 30 and the second electrode 40 at least partially against mechanical damage. In addition, an electrical insulation is created, which increases the operational safety of the heating layer 10. The electric heating layer 10 produced in this way can now be used according to the example as heatable wallpaper for the interior of a building.

According to a further exemplary embodiment, also shown in FIG. 1, the application of heat in step 130 takes place in two stages, wherein in a first step a first application of heat to the first electrode 30 and to the second electrode 40 takes place by means of laser irradiation. In a second step, a second application of heat to the first electrode 30 takes place by means of a first heatable contact pressure element, which comprises two electrically heatable rollers, of which a first electrically heatable roller acts on the first electrode 30 from an upper side of the heating layer 10 and a second electrically heatable roller acts on the first electrode 30 from a lower side of the heating layer 10. At the same time, a second application of heat to the second electrode 40 also takes place in step 130 by means of a second heatable contact pressure element, which also comprises two electrically heatable rollers, of which a first electrically heatable roller acts on the second electrode 40 from an upper side of the heating layer 10 and a second electrically heatable roller acts on the second electrode 40 from a lower side of the heating layer 10.

The melting of the adhesive 60 and the pressing in of the adhesive 60, the first electrode 30 and the second electrode 40 then take place again as described in steps 140 and 150 of FIG. 1. Likewise, pressure is applied to the first electrode 30 and to the second electrode 40 and the first electrode 30 and the second electrode 40 are sealed as already described in steps 160 and 170 of FIG. 1.

FIG. 2 shows, schematically and by way of example, a possible embodiment of an electrical heating layer 10 according to the invention.

The electrical heating layer 10 comprises a planar and electrically conductive layer 20 as well as a first strip-shaped electrode 30 and a second strip-shaped electrode 40. The first electrode 30 and the second electrode 40 are made of zinc. For example, the layer 10 is made of a carbon composition with carbon fibers.

The first electrode 30 and the second electrode 40 can be electrically contacted via the cables 31 and 41.

As can be seen, the first electrode 30 is arranged on the layer 20 at a distance from the second electrode 40, so that a flow of electric current is enabled from the first electrode 30 through the layer 20 to the second electrode 40. Since the layer 20 also has an electrical resistance, electrical energy is converted into heat during the current flow.

The first electrode 30 and the second electrode 40 are arranged on the layer 20 by means of an electrically conductive adhesive 60, forming a planar surface with the upper side of the layer.

For example, the first electrode 30 and the second electrode 40 each have an adhesive structure for a coat of paint on their side facing away from the layer 20.

According to a further exemplary embodiment not shown in FIG. 2, the first electrode 30 is contacted or provided with current by a first electrical supply line and the second electrode 40 is contacted or provided with current by a second electrical supply line. The first electrical supply line and the second electrical supply line are for example made strip-shaped in a manner analogous to the first electrode 30 and the second electrode 40. In addition, the first electrical supply line and the second electrical supply line are also made of zinc in the example.

FIG. 3 shows an exemplary, schematic cross-section of a portion of a possible embodiment of an electrical heating layer 10 according to the invention.

The detail shows the layer 20, which is formed as carbon paper 20 in the example. The first electrode 30, which is made of a zinc alloy, is pressed into the layer 20. The first electrode 30 is slightly recessed into the layer 20 relative to the upper side of the layer 10. From above, the first electrode 30 is also sealed by a polymer strip 50 in the example. Since the first electrode 30 is recessed into the layer 20 in the example, the polymer strip 50 forms a planar surface with the layer 20, so that the heating layer 10 has a “smooth” surface overall.

In order to reliably hold the first electrode 30 in the position assigned to it, pressed into the layer 20, a mechanical and electrical connection is created between the layer 20 and the first electrode 30 by the electrically conductive adhesive 60. The adhesive 60 was liquefied by applying heat and pressed into the fibers of the layer 20 by applying pressure, where it filled the spaces between the fibers that were previously filled with air. As there is no longer any room for the formation of sparks due to ionized air or due to distance between the individual fibers, the risk of fire can also be reduced.

### LIST OF REFERENCE SIGNS

10 Electrical heating layer
20 Layer, carbon paper
30 First electrode
31 Cables
40 Second electrode
41 Cables
50 Polymer strips
60 Conductive adhesive
100 Providing the layer, the first electrode, and the second electrode
110 Applying the adhesive to the first electrode and to the second electrode
120 Arrangement of the first electrode and the second electrode on the layer
130 Laminating the first electrode and the second electrode by applying heat and pressure to the layer
140 Melting the adhesive
150 Pressing the adhesive and the first electrode and the second electrode into the layer
160 Cooling the first electrode and the second electrode
170 Sealing the first electrode and the second electrode with a polymer strip

1. An electrical heating layer,
comprising a planar and electrically conductive layer as well as a first strip-shaped electrode and a second strip-shaped electrode,
wherein the first electrode is arranged on the layer at a distance from the second electrode, so that a flow of electric current from the first electrode through the layer to the second electrode is enabled, and
wherein the layer is designed to convert electrical energy into heat due to its electrical resistance during the current flow,
wherein the first electrode and the second electrode are made of zinc or a zinc alloy.

2. The electrical heating layer according to claim 1,
wherein a first electrical supply line for supplying current to the first electrode and a second electrical supply line for supplying current to the second electrode are also strip-shaped and are made of zinc or a zinc alloy.

3. The electrical heating layer according to claim 1,
wherein the zinc alloy contains tin and/or lead and/or cadmium and/or iron and/or copper and/or aluminum as an alloy component.

4. The electrical heating layer according to claim 1,
wherein the layer comprises electrically conductive fibers.

5. The electrical heating layer according to claim 4,
wherein the layer is formed as a carbon fiber layer, as carbon paper, or as a carbon paint coating on a carrier layer, wherein the electrically conductive fibers are formed as carbon fibers.

6. The electrical heating layer according to claim 1,
wherein the first electrode and the second electrode are arranged on the layer by means of an electrically conductive adhesive.

7. The electrical heating layer according to claim 1,
wherein the first electrode and the second electrode have a surface planar with the layer or are recessed relative to an upper side of the layer.

8. The electrical heating layer according to claim 1,
wherein the first electrode and the second electrode each have an adhesive structure for a paint coating on their side facing away from the layer.

9. The electrical heating layer according to claim 1,
wherein the first electrode and the second electrode are each sealed by a polymer strip and/or in that the layer is completely sealed by a polymer film at least on a surface comprising the first electrode and the second electrode.

10. A method for manufacturing an electrical heating layer according to claim 1,
wherein a first strip-shaped electrode is arranged on a planar and electrically conductive layer and
wherein a second strip-shaped electrode is arranged on the layer at a distance from the first electrode, so that a flow of electric current is enabled from the first electrode through the layer to the second electrode,
wherein the first electrode and the second electrode are made of zinc or a zinc alloy.

11. The method according to claim 10,
wherein the first electrode and the second electrode are arranged on the layer by means of an electrically conductive adhesive,
wherein the adhesive is applied to the first electrode before the arrangement of the first electrode and is applied to the second electrode before the arrangement of the second electrode, or
wherein the adhesive is applied on both sides of a first carrier tape which tape is arranged between the first electrode and the layer, and is applied on both sides of a second carrier tape which is arranged between the second electrode and the layer.

12. The method according to claim 11,
wherein the first electrode and the second electrode are laminated to the layer by means of the electrically conductive adhesive with the application of heat and pressure.

13. The method according to claim 11,
wherein the adhesive is melted by the application of heat and is pressed into the layer by the application of pressure, so that it is completely absorbed by the layer and encapsulates fibers of the layer.

14. The method according to claim 12,
wherein the first electrode and the second electrode are also pressed into the layer by the application of pressure and are held in the layer by the adhesive, so that the first electrode and the second electrode have a planar surface with the layer or are countersunk relative to an upper side of the layer.

15. The method according to claim 12,
wherein the application of heat and the application of pressure are applied simultaneously by a heatable contact pressure element and/or in that the first electrode and the second electrode are cooled after being arranged on the layer.
